(19) United States
(12) Patent Application Publication
(10) Pub. No.: US 2014/0349762 A1
(43) Pub. Date: Nov. 27, 2014

(54) GTG

(71) Applicant: Alfred M. Haas, Oakhurst, NJ (US)

(72) Inventor: Alfred M. Haas, Oakhurst, NJ (US)

(21) Appl. No.: 14/217,276

(22) Filed: Mar. 17, 2014

Related U.S. Application Data
(60) Provisional application No. 61/802,193, filed on Mar. 15, 2013.

(51) Int. Cl. A63F 13/24

(52) U.S. Cl. CPC A63F 13/24
USPC 463/37; 463/1

(57) ABSTRACT

The instant invention is related to methods and means for interacting with real and virtual environments and entities. Various embodiments of the methods and means of the invention may be performed by and/or implemented in hardware, in software, by one or more entities, and/or by some combination of hardware, software and/or one or more entities.

### CROSS-REFERENCE TO RELATED APPLICATIONS

Pursuant to 35 USC §119(e) and as set forth in the Application Data Sheet, this utility application claims the benefit of priority from U.S. Provisional Patent Application No. US 61/802,193 (“the '193 provisional”) which is incorporated herein in its entirety by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

This invention claims priority from the '193 provisional and expressly incorporates by reference the disclosures contained therein in their entirety, including but not limited to all patents, patent applications, and publications which are incorporated by reference in the '193 provisional and which are incorporated by reference herein in their entirety.

In the context of the instant disclosure, the term “software” is taken in the broadest sense of its ordinary meaning and illustrative examples may comprise, but are not limited to, one or more of the following: realized embodiments of algorithms in any form, code written in whole or in part in any programming, scripting or other language (including, but not limited to, popular languages such as C++, Java, Visual Basic, Python, PHP, HTML, and/or device specific machine or assembly languages, etc . . . ), programs, mobile and/or other applications (e.g., those for Android and iOS based systems), applets, scripts, operating systems (OS) and components of OS, embedded and other software and instructions, structured data, op codes, commands, executables, firmware, drivers, virtual machines, and/or instruction sets for a system. Software may operate at many levels including, but not limited to, over a distributed system (e.g., on a cloud computing or mobile network), on a particular device, on a local computer or other machine, embedded in an ASIC or other circuit, and running on top of one or more real or virtual levels, including but not limited to an OS and a hardware level.

In the context of the instant disclosure, the term “hardware” is taken in the broadest sense of its ordinary meaning and illustrative examples may comprise, but are not limited to, one or more of the following: video game systems, computers, smart phones, PDAs, other commercially available electronic devices such as tablet PCs, netbooks, e-readers (e.g., Kindle™ and Nook™), pagers, alarms, beepers, cell phones, hearing aids, watches comprising integrated and/or discrete circuits, monitors and displays, televisions, calculators, iPods™ and MP3 players, speakers, microphones, radios and stereos, remote controls, bar code readers, keyboards, cameras, other input devices, data acquisition systems, other physical devices and systems comprising integrated and/or discrete circuits, CPUs, hard drives, flash USB drives, other flash and solid state drives, programmable logic arrays, FPGAs, CPLDs, microcontrollers, DSPs, receivers, transmitters, drivers, ADC's (analog-to-digital converters), DAC's (digital-to-analog converters), decoders, multiplexers, comparators, latches, gates, op amps, LNA (low noise amplifiers), PLL (phase locked loops), antennae, radio frequency identification (“RFID”) devices, near-field communication (“NFC”) devices, coils, capacitors, inductors, resistors, transformers, solenoids, other analog circuits and components, other digital circuits and components, other mixed-signal circuits and components, optical circuits, other electromagnetic circuits and components, biological and/or chemical circuits, assemblies of memristors, carbon nanotubes, and other circuits and systems comprised of circuits.

Some embodiments of the methods and means of the instant invention may employ one or more existing wireless and/or wired communication protocols, or other custom protocols. Illustrative examples of current and historical protocols, programs and standards for digital communication include: the Internet Protocol Suite; e-mail protocols such as POP (Post Office Protocol), SMTP (Simple Mail Transfer Protocol), IMAP (Internet Message Access Protocol), and MAPI (Messaging Application Programming Interface); web browsers such as Safari™, Internet Explorer™ and Firefox™; messaging programs, protocols and standards such as WLM (Windows Live Messenger), MSNP (Microsoft Notification Protocol), AIM (AOL Instant Messenger), ICQ, XMPP (Extensible Messaging and Presence Protocol), IRC (Internet Relay Chat), MIM (Mobile Instant Messaging), SMS (Short Message Service), WAP (Wireless Area Protocol), GPRS (General Packet Radio Service), WLAN (Wireless Local Area Network), Bluetooth™, and Skype™; mobile standards such as GSM (Global System for Wideband Communications), W-CDMA (Wideband Code Division Multiple Access), LTE (Long Term Evolution), and LTE-Advanced, WirelessMAN (Metropolitan Area Networks)-Advanced; NFC (near-field communications), and many others not addressed here. To the extent that documented versions of these protocols, programs and standards are publicly accessible they are incorporated herein by reference. Likewise, some embodiments of the methods and/or means of the instant invention may employ analog and/or mixed-signal methods of communicating data or information. In addition, some embodiments of the invention employ GPS (Global Positioning System) and aGPS (Assisted Global Positioning System) protocols and/or standards.

The following publications and software packages contain information related to the design, development, fabrication, production, assembly, and other aspects of some embodiments of the disclosed invention—including, but not limited to software and hardware such as sensors and transducers, circuits, transmitters, receivers, housings, wearable and other mobile devices, programmable logic elements and chips, custom ASICs, electrical and mechanical switches, electrical and mechanical regulators, etc. Analysis and Design of Analog Integrated Circuits by Paul R. Gray, Paul J. Hurst, Stephen H. Lewis, Robert G. Meyer, published by John Wiley & Sons, copyright 2001; Digital Principles and Design by Donald D. Givone, published by McGraw Hill copyright 2003; The Sensory Hand, by Mountcastle., published by Harvard Press, copyright 2005; Physics by Paul A. Tipler, published by Worth Publishers, copyright 1976; The New Way Things Work by David Macaulay, published by Houghton Mifflin, copyright 1988; Principles of Neural Science, Fourth Edition by Kandel, Schwartz, and Jessell, published by McGraw-Hill, copyright 2000; The Pharmacological Basis of Therapeutics, Eighth Edition, by Goodman and Gilman, published by Pergamon Press, copyright 1990; CMOS Circuit Design, Layout and Simulation by R. Jacob Baker, published by the Institute of Electrical and Electronics Engineers, copyright 2005; Microelectronic Circuits by Adel S. Sedra and Kenneth C. Smith, published by Oxford University Press, copyright 1998; Thin Film Technology Handbook by Aicha Elshabini-Riad, Fred D. Barlow III, published by McGraw-Hill, copyright 1998; Field and Wave Electromagnetics by David K. Cheng, published by Addison-Wesley, copyright 1989; VLSI for Wireless Communications by Bosco Leung, published by Prentice Hall, copyright 2002; Complete Wireless Design by Cotter W. Sayre, published by McGraw Hill, copyright 2001; Elements of Information Theory, by Thomas M. Cover and Joy A. Thomas, published by Willey Interscience, copyright 1991; Information Theory and Reliable Communication, by Robert G. Gallager, published by John Wiley and Sons, copyright 1968; Principles of Communication Engineering, by John M. Wozencraft and Irwin Mark Jacobs, published by Waveland Press, copyright 1965; Pattern Classification, Second edition by Richard Duda, Peter Hart and David Stork, published by John Wiley & Sons, Inc., copyright 2001; C++ How to Program, Third edition by H. Dietel & P. Dietel, published by Prentice Hall, copyright 2001; Professional Android 2 Application Development by Roto Meier, published by Wiley Publishing, Inc., copyright 2010; the various versions of the Android SDK; the various versions of the Internet Protocol Suite; Programming in Objective-C, Fifth Edition by Stephen G. Kochan, published by Addison-Wesley, copyright 2103; the various versions of the iOS SDK; the various versions of the Windows and Windows Mobile SDKs. All publications cited herein are hereby incorporated by reference in their entirety.

The discussion of the background of the invention herein is included to explain the context of the invention. Although each of the patents, patent applications, and publications cited herein are hereby incorporated by reference, neither the discussion of the background nor the incorporation by reference is to be taken as an admission that any aspect, element, embodiment, or feature of the invention was published, known, or part of the common general knowledge as of the priority date of any claims of the invention.

### BRIEF SUMMARY OF THE INVENTION

The instant invention is related to methods and means for interacting with real and virtual environments and entities.

### BRIEF DESCRIPTION OF THE SEVERAL VIEWS OF THE DRAWINGS

FIGS. 1-4 illustrate schematic representations of examples of embodiments of Tron gloves. FIG. 1 illustrates a schematic representation of an example of an embodiment of a Tron glove comprising a plurality of pancake style vibrating motor transduction elements. FIG. 2 illustrates a schematic representation of an example of an embodiment of a Tron glove comprising a plurality of nanowire transduction elements. FIG. 3 illustrates a schematic representation of an example of an embodiment of a Tron glove comprising a plurality of transduction elements each of which comprises a sealed compartment of iron or other magnetizable filings in fluid surrounded by addressable electromagnets. FIG. 4 illustrates a schematic representation of an example of an embodiment of a Tron glove comprising a plurality of transduction elements each of which comprises a sealed compartment of piezoelectric polymer filaments in fluid surrounded by addressable conductors.

FIGS. 5A-D show schematics of various specific examples of embodiments of game transducers responding to a signal indicating a goal has been scored; 5A-D respectively represent a band, a cuff, a helmet and a remote control.

FIGS. 6 and 7 represent schematic illustrations of specific examples of embodiments of toy avatars responding respectively to a TV program and a computer game.

FIGS. 8-14 illustrate 3D schematics of the components comprising the housing of an example of an embodiment of a game band. FIGS. 8 and 9 illustrate 3D schematics of two different examples of an element of an embodiment of a game band. FIGS. 10-14 illustrate 3D schematics of several different components of another element of an embodiment of a game band. FIG. 15 illustrates a partially assembled example of a prototype of an embodiment of a game band, comprising a rigid base, a microcontroller, a communications module, an accelerometer, a vibrating transduction element, and a power supply.

### DETAILED DESCRIPTION OF THE INVENTION

The instant invention is directed to methods and means for interacting with real and virtual environments and entities. Some embodiments of the methods and means of the invention incorporate functionality including, but not limited to communication, sensing, display and data processing elements.

In some embodiments, the instant invention comprises game avatars or toys that one can interact with in real life and which may have digital game representations as well. In some embodiments, the instant invention comprises talking teddy bears and other stuffed animals that can communicate and/or interact with users via sound and televisions and/or computers (and lately cell phones) via sound and or optical or RF communication. In some embodiments, the instant invention comprises avatars which can interact with a TV, a game, and people. In some such embodiments, the avatars include a memory chip inside them to preserve attributes and other data pertinent to a user and/or a game.

Some embodiments of the instant invention are directed to advanced technology for bringing people closer to their games and television programming. Some embodiments comprise what I many years ago dubbed the “Tron glove” and some embodiments comprise “game transducers.” Essentially a Tron glove is a worn apparatus with fine haptic feedback—that can realistically reproduce the feel of virtual objects to a user. In some embodiments, this depends on the density and quality of the transduction elements comprising the glove. In some embodiments, subjective user perception (see e.g. Mountcastle) plays a role. In some embodiments, game transducers convey a physical tactile stimuli corresponding with real-life events, for example a goal, a score, a kick, a hit, etc. In some embodiments, game transducers may be used for fans in a stadium or arena, or an individual watching on TV. In some embodiments, game transducers may be synchronized using RF communication, for example over a Smart TV WiFi communication, via cell phone, and over other devices.

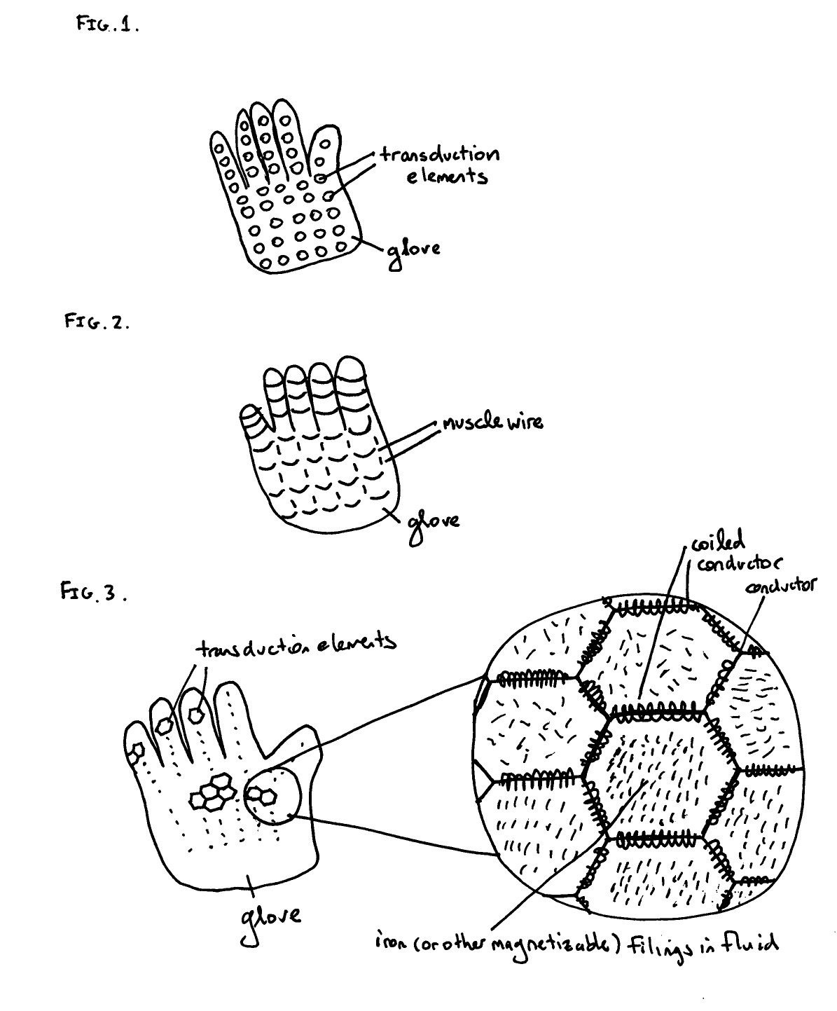

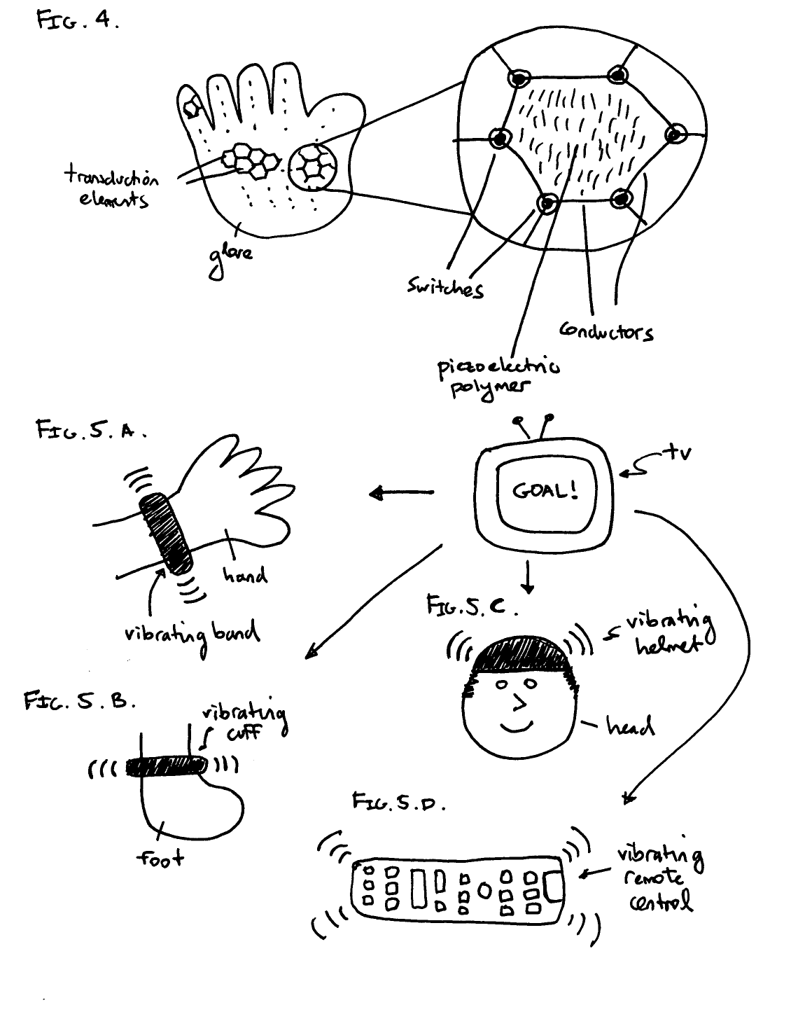

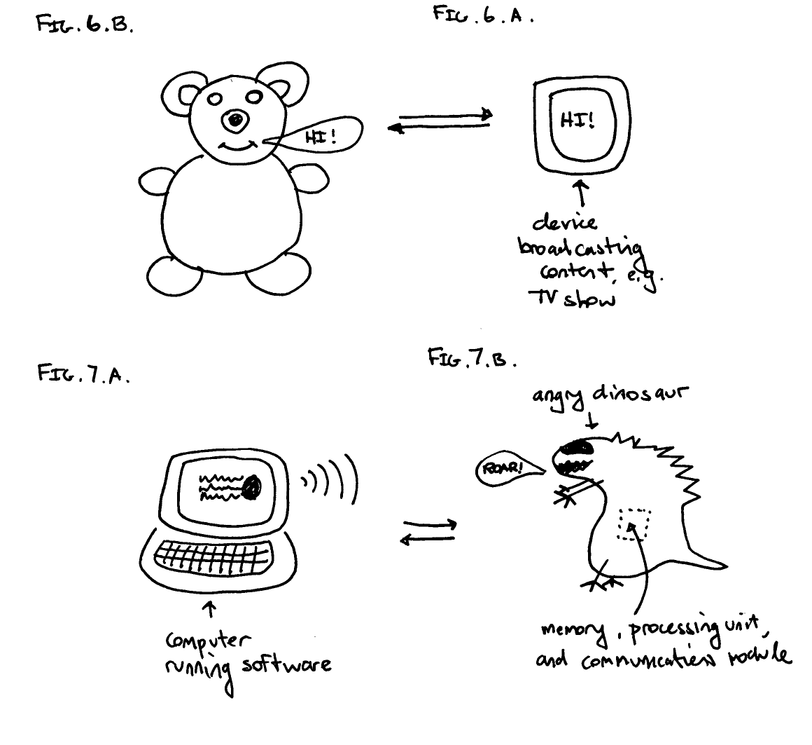

FIGS. 1-4 illustrate schematic representations of examples of embodiments of Tron gloves. FIG. 1 illustrates a schematic representation of an example of an embodiment of a Tron glove comprising a plurality of pancake style vibrating motor transduction elements. FIG. 2 illustrates a schematic representation of an example of an embodiment of a Tron glove comprising a plurality of nanowire transduction elements. FIG. 3 illustrates a schematic representation of an example of an embodiment of a Tron glove comprising a plurality of transduction elements each of which comprises a sealed compartment of iron or other magnetizable filings in fluid surrounded by addressable electromagnets. FIG. 4 illustrates a schematic representation of an example of an embodiment of a Tron glove comprising a plurality of transduction elements each of which comprises a sealed compartment of piezoelectric polymer filaments in fluid surrounded by addressable conductors.

FIGS. 5A-D show schematics of various specific examples of embodiments of game transducers responding to a signal indicating a goal has been scored; 5A-D respectively represent a band, a cuff, a helmet and a remote control. FIGS. 6 and 7 represent schematic illustrations of specific examples of embodiments of toy avatars responding respectively to a TV program and a computer game.

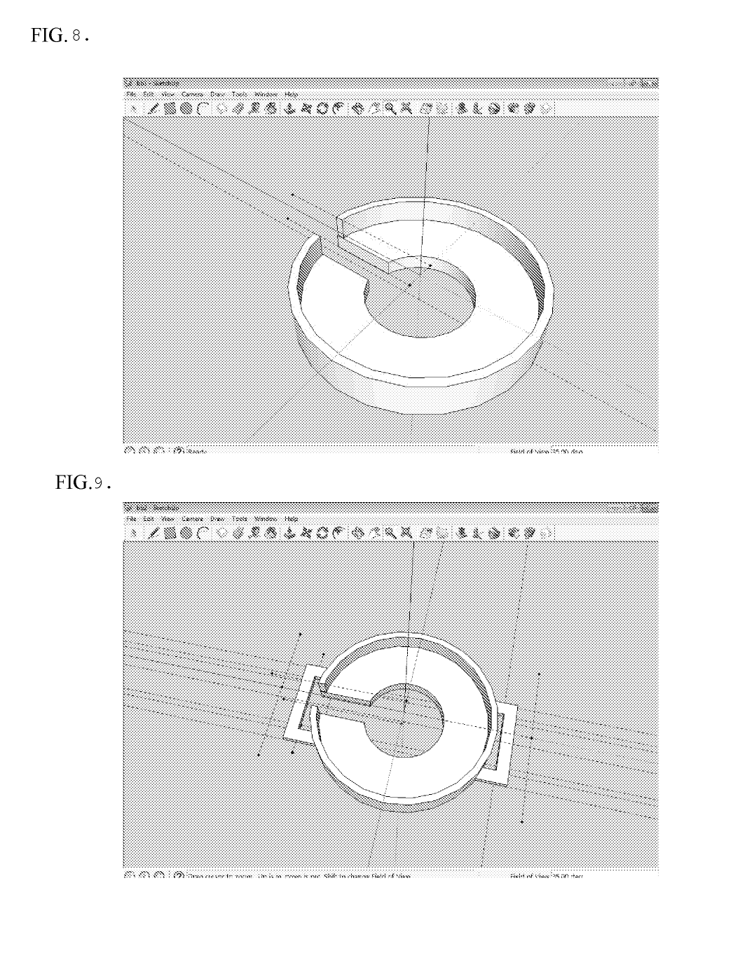

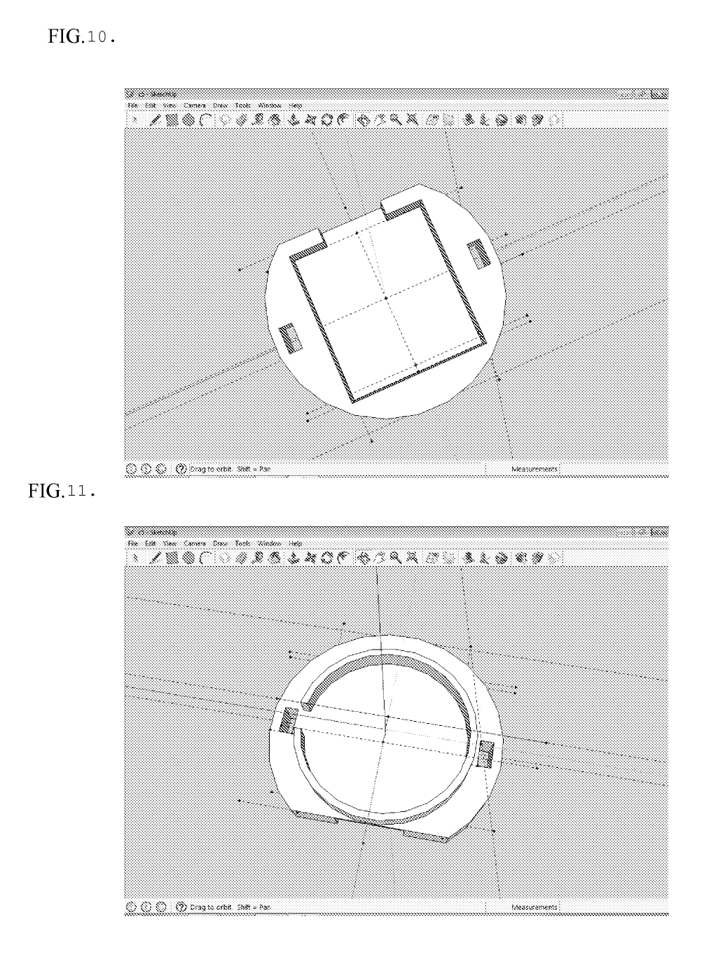

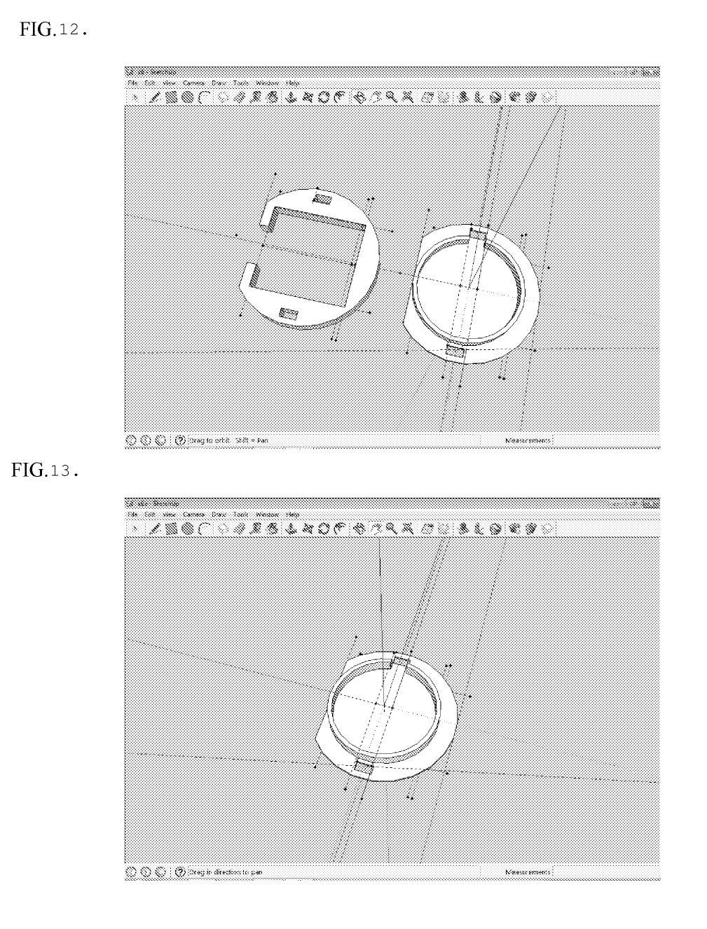

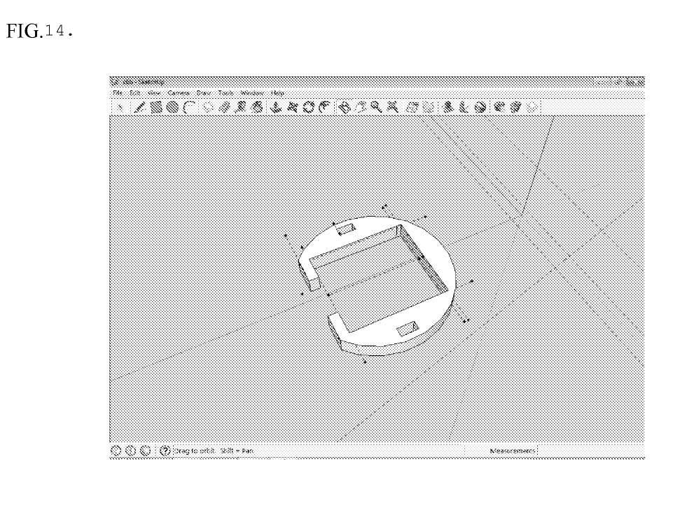

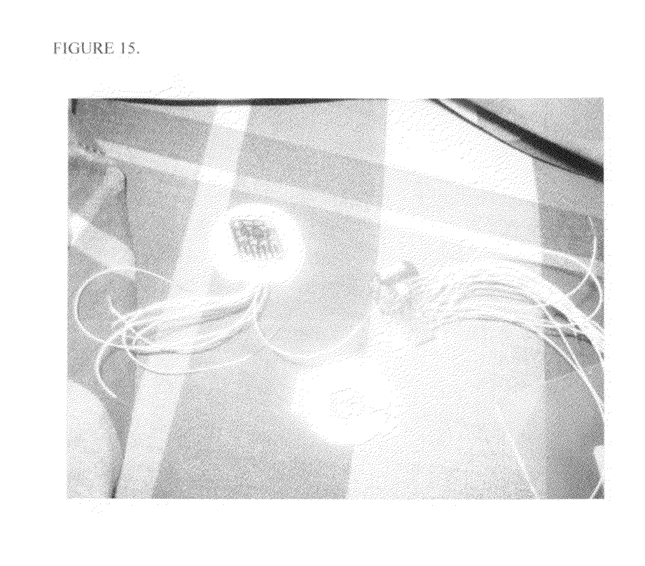

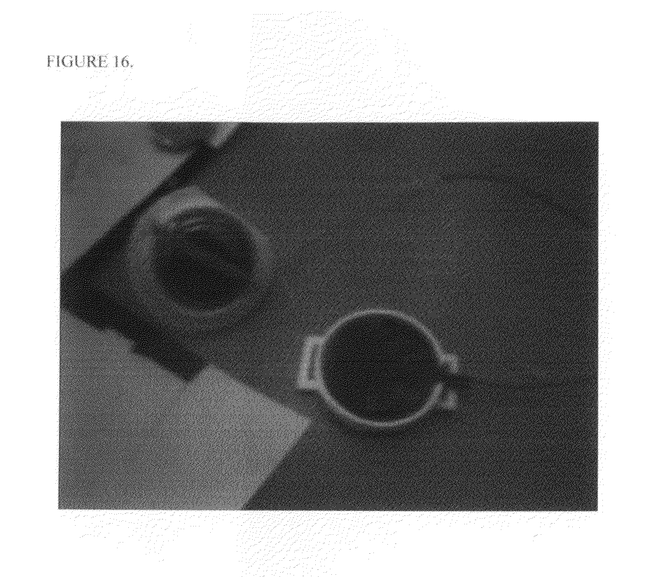

FIGS. 8-14 illustrate 3D schematics of the components comprising the housing of an example of an embodiment of a game band. FIGS. 8 and 9 illustrate 3D schematics of two different examples of an element of an embodiment of a game band, comprising a rigid base onto which a power supply and a mounting surface comprising a microcontroller, a communications module and an accelerometer may be affixed. In these Figures, the center slot is for an embedded vibrating transduction element; in FIG. 9, the square loops are designed to accommodate a flexible band, e.g. a watch band. FIGS. 10-14 illustrate 3D schematics of several different components of another element of an embodiment of a game band, comprising mounting surfaces for a microcontroller, communications module, and accelerometer, and a cover for a power supply. FIG. 15 illustrates a partially assembled example of a prototype of an embodiment of a game band, comprising a rigid base, a microcontroller, a communications module, an accelerometer, a vibrating transduction element, and a power supply. Although these prototypes employ commercial-off-the-shelf circuit assemblies, subsequent designs are custom.

One method for generating avatar shells (housings, bodies) is 3D printing. I had a few ideas for 3D printing that I wanted to put into the system before the PTO went first-to-file: (1) 3D printing magnetizable material and/or magnets: some embodiments combine iron (and/or other magnetizable metal) filings into melted polymer and then magnetize the extruded filament after it cools; (2) print memristors: TiO2 is a memristive compound and it is also an additive found in some white polymer used in 3D printing; likewise, organic memristors may be printed layer by layer onto a suitable substrate—in some embodiments using a variant of inkjet cell printing that the inventor and others have implemented; (3) 3D virtual sculpting: 3D drawing tools like SketchUp are a bear to use with respect to free-form non-square-non-cube models. Other software is too expensive. I've been developing a 3D virtual sculpting tool and application that uses a sculpting tool (accelerometer+in some trials Kinect/Wii position sensing) to virtually “carve” a 3D image from a block of pixels. The resulting “sculpture” is then translated into a 3D model via a method akin to what the inventor understands the program “SlicR” to do. In some embodiments, the tool is wireless and may be implemented using hand gestures, for example in conjunction with an imaging device, e.g. a Kinect.

With respect to the disclosed embodiments, salient feature, user and sensor data may be stored in any accessible format and any form of memory, including but not limited to, written and printed media, magnetic storage media such as hard drives and tape drives and cassettes, optical storage media such as vinyl records, CDs, DVDs, and Blu Ray discs, electronic memory such as RAM, ROM, EEPROM, flash memory, and other solid state memories, analog floating gate memory, capacitive memories, chalcogenide memories, memristor-based memories, and any other existing form including human memory of individuals.

In some embodiments of the invention, measured, ascertained and/or computed data may be transmitted and/or received by and/or retrieved by a game band or glove and/or other system comprising software and/or hardware. Such data may include, for example, but is not limited to: absolute location information, e.g. GPS coordinates; relative location information, e.g. grid coordinates; the distance or proximity between an entity, place or thing and a user and/or a device worn, carried by, or otherwise proximate to a user; the relative location of an entity, place or thing with respect to a user and/or to a device proximate to a user; the date; the time; environmental conditions such as weather, temperature, humidity and altitude; and other data relevant to some embodiments of the methods and means of the invention, Individual users and/or entities may elect to transmit or to have certain data concerning themselves transmitted to and/or retrieved by such a system. In some embodiments, a game band or glove and/or other system may ascertain data by one or more means including for example, but not limited to, measuring it, generating or observing it (e.g. pseudo-random numbers), retrieving it from memory, receiving it from users and/or entities via an input means, receiving it from external devices, software and/or hardware, including storage media; receiving it through a network such as the world-wide-web, retrieving it from publicly accessible or private disclosed records, extracting it from software and/or hardware employed by a user and/or entity, sensing it, and/or from any other accessible source. In addition, in some embodiments, a database or collection of data pertaining to users, things, entities and/or locations may be maintained (e.g., on the hard drives of a network server or other hardware), which could ease the computational and/or bandwidth load for the system so that only data which changed, e.g. user/entity/thing location, might be transmitted and/or detected on a repeated basis.

In some embodiments of the invention, transmission and receiving may be by an existing wireless digital protocol (see below), by a custom or future wireless protocol, by analog radio frequency or other EM spectrum (including but not limited to visible, IR, and UV light) transmission, by sound, or any other means of wireless transmission, or via wires, cables, and transferable storage media such as flash drives and data cards.

Various embodiments of the invention may be practiced in many ways, including for example, but not limited to, in real-time, continuously, periodically, regularly, on a schedule, at some prescribed intervals or times, with a given refresh and/or update rate, clocked, and/or asynchronously in an event-driven fashion. Event-driven broadly means triggered by or otherwise correlated in time or sequence with the occurrence of an event. Events include, but are not limited to, the detection of an entity, place and/or thing meeting certain criteria and/or satisfying certain conditions, the recognition that an entity, place and/or thing meets certain criteria and/or satisfies certain conditions, an entity crossing a threshold such as a boundary between a vicinity and an area outside that vicinity, the satisfaction of one or more environmental or other conditions, reaching a detected threshold value or level, the occurrence of something, a change in state, or upon other conditions or occurrences.

It should be noted that the figures and examples they represent are provided for illustrative purposes only and are not intended to limit the scope of the instant invention.

Although the foregoing invention has been described in some detail by way of illustration and example for purposes of clarity and understanding, it will be readily apparent to those of ordinary skill in the art in light of the teachings of this invention that certain changes and modifications may be made thereto without departing from the spirit and purview of this application. All publications, patents, and patent applications cited herein are hereby incorporated by reference in their entirety.

I claim:

1. A device comprising hardware for interacting with real and virtual environments and entities.

2. The device of claim 1 comprising an avatar.

3. The device of claim 1 comprising a Tron glove.

4. The device of claim 1 comprising a game transducer.

5. The device of claim 1 comprising a game band.

6. The device of claim 1 comprising a virtual 3D sculpting tool.

7. A method for interacting with real and virtual environments comprising the steps of interacting with one or more of the following: an avatar, a Tron glove, a game transducer, a game band, and a virtual 3D sculpting tool.
